(19) United States
(12) Patent Application Publication
(10) Pub. No.: US 2011/0162015 A1
(43) Pub. Date: Jun. 30, 2011

(54) INFLIGHT COMMUNICATION SYSTEM

(75) Inventors: John D. Holyoake, Irvine, CA (US); Timotheus A. Beuman, Chino Hills, CA (US); James M. Reardon, San Juan Capistrano, CA (US)

(73) Assignee: LUMEXIS CORP, Irvine, CA (US)

(21) Appl. No.: 12/898,482

(22) Filed: Oct. 5, 2010

Related U.S. Application Data
(60) Provisional application No. 61/278,246, filed on Oct. 5, 2009.
(60) Provisional application No. 61/278,261, filed on Oct. 5, 2009.
(60) Provisional application No. 61/278,309, filed on Oct. 5, 2009.

(51) Int. Cl. H04N 7/18

(52) U.S. Cl. 725/76

(57) ABSTRACT

An inflight communication system is disclosed. In some embodiments, the system includes a video display unit (VDU) with a detachable module having a plurality of user interface elements thereon to facilitate, for example, recovery from failure of one of the user interface elements in that the detachable module can be replaced without replacing the entire VDU. In some embodiments, the system includes a VDU with integrated and/or rendered flight attendant call button and/or reading light control button. In some embodiments, the system includes a public address (PA) system that bypasses the IFE head end servers when delivering PA audio to seat audio/visual (A/V) systems, thereby reducing or eliminating the risk of PA audio output failure on seat A/V systems due to server crashes and improving synchronization between the PA audio output on the public loudspeakers and the seat A/V systems.

### CROSS-REFERENCE TO RELATED APPLICATIONS

This application claims the benefit of U.S. provisional application No. 61/278,246, entitled “INFLIGHT COMMUNICATION SYSTEM VIDEO DISPLAY UNIT WITH ENHANCED USER INTERFACE,” filed on Oct. 5, 2009; U.S. provisional application No. 61/278,261, entitled “INFLIGHT COMMUNICATION SYSTEM WITH HIGH RELIABILITY AND HIGHLY SYNCHRONIZED PUBLIC ADDRESS AUDIO OUTPUT,” filed on Oct. 5, 2009; and U.S. provisional application No. 61/278,309, entitled “INFLIGHT COMMUNICATION SYSTEM VIDEO DISPLAY UNIT WITH DETACHABLE USER INTERFACE MODULE,” filed on Oct. 5, 2009, the contents of each of which are incorporated herein by reference in their entirety.

### BACKGROUND

On a conventional passenger aircraft equipped with an inflight entertainment (IFE) system, often each passenger seat is equipped with a VDU for the entertainment of the passenger. Generally, VDUs each have a user interface that includes user interface elements, such as an audio output jack. The user interface elements can be highly susceptible to malfunction or breakage as a result of normal wear and tear or passenger misuse.

Unfortunately, VDUs are often integrated in a way that if one of the user interface elements malfunctions or breaks, the only way to restore full service to the passenger is to replace the entire VDU. This is a cumbersome task that is generally not attempted in flight. Moreover, such integration often requires an airline to maintain sufficient spare VDUs at a high number of its destination airports to maintain high availability of its IFE system. Additionally, the airline generally must bear the cost of maintaining (direct or through contract) trained maintenance personnel at its destination airports to service failed VDUs. Furthermore, mixed fleet airlines (i.e., airlines having both wide-body and narrow-body aircraft) may have to separately spare (e.g., keep an inventory of extras) and maintain wide-body VDUs and narrow-body VDUs since its wide-body VDUs may not be usable in narrow-body applications and vice versa, e.g., VDUs for wide-body applications may include different user interface elements than narrow-body VDUs.

Furthermore, on a conventional passenger aircraft, each passenger seat is often equipped with access to a flight attendant call button and a reading light on/off button for the convenience and safety of the passenger. In a narrow-body aircraft, these buttons are typically positioned on the cabin ceiling above the passenger's head. Overhead positioning of these buttons can be inconvenient for the passenger since the buttons are out of the passenger's sight line and require the passenger to reach up to activate and deactivate them. In a wide-body aircraft, these buttons are typically positioned on one of the passenger's armrests. Armrest positioning of these buttons is in some respects more convenient for the passenger. However, these buttons are still out of the passenger's sight line and space constraints of passenger armrests limit the size of these buttons, which can make them difficult to find, activate and deactivate.

In a narrow-body aircraft, there is typically no integration between the IFE system and these buttons. The flight attendant call button and the reading light on/off button are installed overhead as a separate system and maintained as a separate system, thereby adding cost and complexity to both the installation and operation of both systems. In a wide-body aircraft, the IFE system is typically integrated with these buttons. In such cases, the flight attendant call button and the reading light on/off button are integrated on a passenger control unit (PCU) installed in the passenger armrest. Installation of the PCU in the passenger armrest often adds cost and complexity to the installation and operation of the IFE system.

Furthermore, in conventional IFE systems, a passenger typically receives entertainment audio through a headset connected to a headset jack located at or near the passenger's seat. One safety requirement for IFE systems is that such systems do not interfere with a passenger's ability to hear PA system announcements. Therefore, in most inflight communication systems, when the PA system is in use entertainment audio received via the headset is overridden with PA audio, which is typically accomplished by interfacing the cabin intercom system (CIS) with the head end of the IFE system. Moreover, an inflight communication system should maintain synchronization within at least 33-milliseconds between PA audio transmitted over the headset and PA audio transmitted over overhead loudspeakers, as latencies greater than 33 milliseconds are detectable by humans and may make PA audio difficult to understand.

### SUMMARY

The present disclosure relates to inflight communication systems and, more particularly, to an inflight communication system having a public address (PA) system that bypasses the IFE head end servers when delivering PA audio to seat audio/visual (A/V) systems, and/or having a video display unit (VDU) having a detachable user interface module, and/or having a VDU with an enhanced user interface.

In some embodiments, a VDU for an inflight communication system includes an integrally mounted detachable module having a plurality of user interface elements thereon. The VDU can facilitate recovery from failure of one of the user interface elements in that the detachable module can be replaced without replacing the entire VDU. In addition, the VDU can enable an airline to employ a single type of VDU base for its entire fleet of wide-body and narrow-body aircraft. In some embodiments, a narrow-body detachable module (e.g., having X user interface elements) may be coupled with the VDU base, and a wide-body detachable module (e.g., having X or more or fewer than X user interface elements) may be coupled with the same VDU base.

In some embodiments, a VDU for an inflight communication system includes a VDU base having a video display, a network interface, and one or more processors operatively coupled with the network interface; and a detachable module integrally mounted to the VDU base and having a plurality of user interface elements operatively coupled with at least one of the processors.

In some embodiments, the user interface elements include an auxiliary input.

In some embodiments, the user interface elements include an audio output jack.

In some embodiments, the user interface elements include a flight attendant call button.

In some embodiments, the user interface elements include a reading light control button.

In some embodiments, the detachable module has electrical contacts that interface with electrical contacts on the VDU base to render the user interface elements operative.

In some embodiments, the detachable module is engaged with the VDU base by moving the detachable module into abutment with the VDU base.

In some embodiments, the detachable module is held in engagement with the VDU base using a mounting screw.

In some embodiments, the video display includes a touch screen.

In some embodiments, the VDU base further includes a credit card reader.

In some embodiments, a VDU base for an inflight communication system includes a video display, a network interface, one or more processors operatively coupled with the network interface, and electrical contacts operatively coupled with at least one of the processors, wherein the VDU base is adapted to interchangeably receive using integral mounting and render operative via the electrical contacts a first detachable module having a first set of user interface elements and a second detachable module having a second set of user interface elements, wherein the first and second sets include different user interface elements.

In some embodiments, the first detachable module is a wide-body aircraft detachable module and the second detachable module is a narrow-body aircraft detachable module.

In some embodiments, the second set of user interface elements is a subset of the first set of user interface elements. For example, in some embodiments each of the user elements in the second set of user elements is also included in the first set of user elements.

In some embodiments, the first and second sets each include an auxiliary input and an audio output jack.

In some embodiments, the first set includes a flight attendant call button and a reading light control button and the second set does not include a flight attendant call button and does not include a reading light control button.

In some embodiments, a VDU assembly for an inflight communication system includes a VDU base having a video display, a network interface, one or more processors operatively coupled with the network interface and a module receiving area having electrical contacts, and a detachable module integrally mountable to the base at the module receiving area and having a plurality of user interface elements, wherein when the detachable module is integrally mounted to the base at the module receiving area the user interface elements are operatively coupled via the electrical contacts with at least one of the processors.

In some embodiments, a VDU for an inflight communication system has an integral flight attendant call button and/or reading light control button. Incorporating one or more of these buttons into a VDU enables these buttons to be positioned on a seat back where they are in the passenger's sight line and where space constraints are less severe. Moreover, incorporating these buttons into a VDU can simplify or eliminate armrest PCUs and overhead passenger controls, which can reduce or eliminate the installation, operating and maintenance costs associated with a conventional line replaceable unit of an inflight communication system.

In some embodiments, a VDU for an inflight communication system includes a user interface having a video display and a flight attendant call button, a network interface, and one or more processors operatively coupled with the user interface and the network interface, wherein under control of at least one of the processors in response to depressing the flight attendant call button the video display unit transmits via the network interface a signal indicative of status of the flight attendant call button.

In some embodiments, the user interface further includes a reading light control button, and under control of at least one of the processors in response to depressing the reading light control button the video display unit transmits via the network interface a signal indicative of status of the reading light control button.

In some embodiments, the video display unit is mounted to a seat back.

In some embodiments, the flight attendant call button is a mechanical button.

In some embodiments, the flight attendant call button is a touch screen button.

In some embodiments, the network interface is communicatively coupled with an inflight entertainment distribution network.

In some embodiments, a video display unit for an inflight communication system includes a user interface having a video display and a reading light control button, a network interface, and one or more processors operatively coupled with the user interface and the network interface, wherein under control of at least one of the processors in response to depressing the reading light control button the video display unit transmits via the network interface a signal indicative of status of the reading light control button.

In some embodiments, the user interface further includes a flight attendant call button, and under control of at least one of the processors in response to depressing the flight attendant call button the video display unit transmits via the network interface a signal indicative of status of the flight attendant call button.

In some embodiments, the video display unit is mounted to a seat back.

In some embodiments, the reading light control button is a mechanical button.

In some embodiments, the reading light control button is a touch screen button.

In some embodiments, the network interface is communicatively coupled with an inflight entertainment distribution network.

In some embodiments, an inflight communication system includes a cabin management system having one or more attendant call lights, and a seatback video display unit operatively coupled with the cabin management system via an inflight entertainment distribution network, wherein in response to a signal received from the seatback video display unit indicative of status of a flight attendant call button the cabin management system regulates power to one or more of the attendant call lights.

In some embodiments, the attendant call lights include a galley section attendant call light and a passenger section attendant call light.

In some embodiments, the signal indicates on/off status of the flight attendant call button and the cabin management system turns-on/off the attendant call lights in response to the signal.

In some embodiments, the signal indicates “on” status of the flight attendant call button and a public address system outputs an audible tone in response to the signal.

In some embodiments, the public address system outputs the audible tone periodically.

In some embodiments, an inflight communication system includes a cabin management system having a passenger reading light, and a seatback video display unit operatively coupled with the cabin management system via an inflight entertainment distribution network, wherein in response to a signal received from the seatback video display unit indicative of status of a reading light control button the cabin management system regulates power to the passenger reading light.

In some embodiments, the signal indicates on/off status of the reading light control button and the cabin management system turns on/off the passenger reading light in response to the signal.

In some embodiments, the signal indicates dimmer status of the reading light control button and the cabin management system dims or brightens the passenger reading light in response to the signal.

In some embodiments, an inflight communication system that bypasses IFE head end servers when delivering PA audio to seat A/V systems, thereby reducing or eliminating the risk of PA audio output failure on seat A/V systems due to IFE head end server failure and/or improving synchronization between PA audio outputted on public loudspeakers and seat A/V systems. In some embodiments, such an inflight communication system includes a CIS having a public loudspeaker and an IFE system operatively coupled with the CIS and having at least one IFE head end server and a plurality of seat A/V systems, wherein each seat A/V system receives an entertainment audio signal from the IFE head end server and a PA audio signal and keyline status signal from the CIS and outputs either the entertainment audio signal or the PA audio signal based on the keyline status signal.

In some embodiments, each seat A/V system generates an audio selection signal based on the keyline status signal and outputs either the entertainment audio signal or the PA audio signal based on the audio selection signal.

In some embodiments, the PA audio signal and the keyline status signal bypass the IFE head end server en route between the CIS and each seat A/V system. In some embodiments, the PA audio signal and the keyline status signal are routed from the CIS to an aircraft interface unit and directly to the IFE distribution network for routing to a seat A/V system.

In some embodiments, each seat A/V system further receives an entertainment video signal from the IFE head end server and outputs either the entertainment video signal or a video interrupt signal based on the keyline status signal.

In some embodiments, the CIS outputs the PA audio signal on the public loudspeaker.

In some embodiments, the IFE system and the CIS are operatively coupled via an aircraft interface unit.

In some embodiments, each seat A/V system is operatively coupled with the CIS and the IFE head end server via an IFE distribution network.

In some embodiments, each seat A/V system receives packets having the entertainment audio signal, the PA audio signal and the keyline status signal.

In some embodiments, a seat A/V system for an inflight communication system enables bypassing of IFE head end servers when delivering PA audio to the seat A/V system. In some embodiments, such a seat A/V system for an inflight communication system includes at least one A/V input, an audio output and an audio selection switch operatively coupled between the A/V input and the audio output, wherein the audio selection switch is adapted to output on the audio output either an entertainment audio signal or a PA audio signal received on the A/V input based on an audio selection signal. In some embodiments, the seat A/V system for an inflight communication system is communicatively linked to one or more IFE head end servers via an IFE distribution network.

In some embodiments, the seat A/V system further includes an entertainment processor and a passenger safety processor operatively coupled between the audio selection switch and the A/V input, wherein the entertainment processor is adapted to provide the entertainment audio signal to the audio selection switch and the passenger safety processor is adapted to provide the PA audio signal to the audio selection switch.

In some embodiments, the passenger safety processor is further adapted to provide the audio selection signal to the audio selection switch.

In some embodiments, the seat A/V system further includes a network switch operatively coupled between the audio selection switch and the A/V input, wherein the network switch is adapted to segregate entertainment signals received on the A/V input from PA signals received on the A/V input, provide the entertainment signals to the entertainment processor, and/or provide the PA signals to the passenger safety processor.

In some embodiments, an inflight communication system routes PA audio through an IFE system before outputting the PA audio on a public loudspeaker, thereby improving synchronization between PA audio output on the public loudspeaker and the seat A/V systems. In some embodiments, such an inflight communication system includes a CIS having a public loudspeaker, and an IFE system operatively coupled with the CIS and having a plurality of seat A/V systems and a loopback converter, wherein in response to a PA audio signal received from the CIS the IFE system outputs the PA audio signal on each seat A/V system and returns the PA audio signal to the CIS via the loopback converter whereupon the CIS outputs the PA audio signal on the public loudspeaker.

In some embodiments, the CIS has a handset and the PA audio signal is received by the CIS via the handset.

In some embodiments, the loopback converter and the seat A/V systems are of a single line replaceable unit (LRU) type.

In some embodiments, the IFE system and the CIS are operatively coupled via an aircraft interface unit.

In some embodiments, each seat A/V system receives an entertainment audio signal from an IFE head end server and the PA audio signal and a keyline status signal from the CIS and outputs the PA audio signal based on the keyline status signal.

In some embodiments, each seat A/V system further receives an entertainment video signal from the IFE head end server and outputs a video interrupt signal based on the keyline status signal.

In some embodiments, each seat A/V system generates an audio selection signal based on the keyline status signal and outputs the PA audio signal based on the audio selection signal.

In some embodiments, the PA audio signal and the keyline status signal bypass the IFE head end server between the CIS and each seat A/V system.

In some embodiments, each seat A/V system is operatively coupled with the CIS and the IFE head end server via an IFE distribution network.

In some embodiments, the IFE distribution network includes fiber optics.

In some embodiments, each seat A/V system receives packets having the entertainment audio signal, the PA audio signal and the keyline status signal.

These and other aspects will be better understood by reference to the following detailed description taken in conjunction with the drawings that are briefly described below. Of course, the invention is defined by the appended claims.

### BRIEF DESCRIPTION OF THE DRAWINGS

FIG. 1 schematically shows an embodiment of an inflight communication system for an aircraft including an embodiment of a VDU.

FIG. 2 schematically shows an embodiment of the cabin positioning of the elements of the inflight communication system of FIG. 1.

FIG. 3 schematically shows the VDU of FIG. 1 in further detail.

FIG. 4 schematically shows an embodiment of a wide-body VDU assembly.

FIG. 5 schematically shows an embodiment of a narrow-body VDU assembly.

FIG. 6 schematically shows a conventional inflight communication system.

FIG. 7 schematically shows an embodiment of an inflight communication system with high reliability PA audio output including some embodiments of seat A/V systems.

FIG. 8 schematically shows an embodiment of a seat A/V system that is representative one of the seat A/V systems of FIG. 7.

FIG. 9 schematically shows an embodiment of an inflight communication system with high reliability and highly synchronized PA audio output including an embodiment of a loopback converter.

FIG. 10 schematically shows an embodiment of the loopback converter of FIG. 9 in more detail.

FIG. 11 schematically shows another embodiment of a loopback converter.

### DETAILED DESCRIPTION

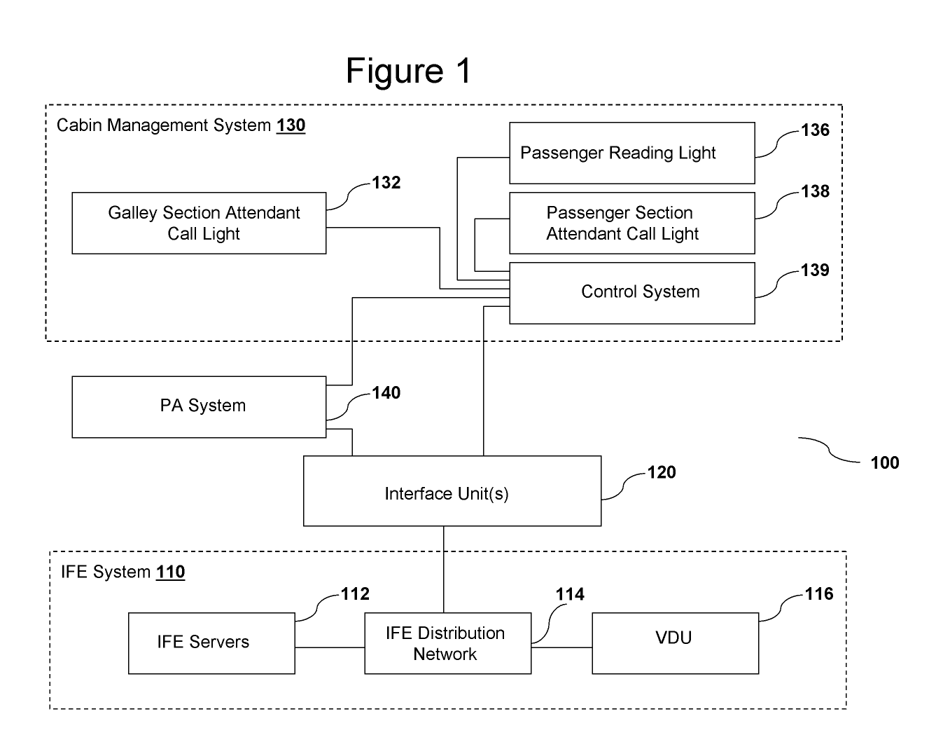

FIG. 1 shows a communication system 100 for a vehicle, e.g., an aircraft inflight communication system. The illustrated inflight communication system 100 includes an IFE system 110 communicatively coupled via one or more interface units 120 to a cabin management system 130 and a PA system 140.

Generally, the IFE system 110 includes IFE servers 112, an IFE distribution network 114 and a VDU 116. While only one VDU 116 is shown, a plurality of VDUs are typically provided, e.g., a VDU positioned at or near the seat for every passenger on the aircraft. The IFE distribution network can be any type of communicative connection, e.g., fiber optic, copper wire, coaxial cable, wireless system, or the like.

The cabin management system 130 shown includes a galley section attendant call light 132, a passenger reading light 136, a passenger section attendant call light 138, and a control system 139. While only one passenger reading light 136 and passenger section attendant call light 138 are shown, a passenger reading light is typically provided to each passenger and a passenger section attendant call light is typically provided to a group of adjacent passengers, e.g., three adjacent passengers.

Several types of signals can be communicated between VDU 116 and other elements of inflight communication system 100 via IFE distribution network 114. For example, some embodiments communicate audio/video entertainment signals originating from IFE servers 112, PA audio signals and PA keyline status signals originating from PA system 140, touch screen input signals, card input signals, and/or auxiliary input signals originating from VDU 116 and destined for IFE servers 112, and/or flight attendant call signals and reading light control signals originating from VDU 116 and destined for control system 139. These signals are typically carried between VDU 116 and the other elements of inflight communication system 100 in packets, such as Ethernet packets.

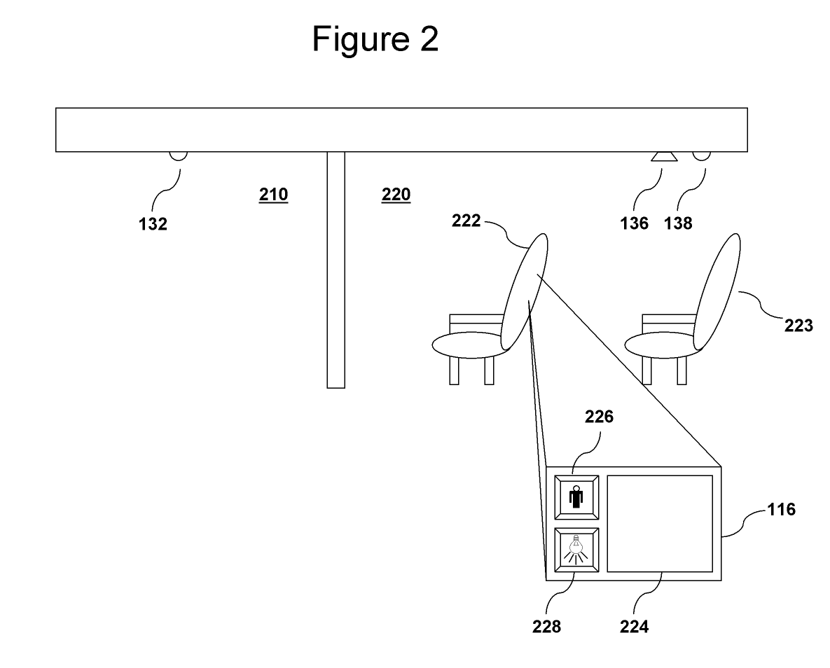

FIG. 2 schematically shows cabin positioning of elements of the inflight communication system 100 of the embodiment of FIG. 1. The illustrated cabin includes a galley section 210 and a passenger section 220. Galley section attendant call light 132 is often mounted to the cabin ceiling in galley section 210, though other locations in the aircraft are possible. Passenger reading light 136 and/or passenger section attendant call light 138 can be mounted to the cabin ceiling in passenger section 220, such as above a passenger seat 223. VDU 116 is generally mounted to the back of a passenger seat 222 for use by a passenger sitting in passenger seat 223 immediately behind passenger seat 222. VDU 116 can include a touch screen video display 224, a flight attendant call button 226, and a reading light control button 228, among other user interface elements. Generally, the IFE servers 112 (FIG. 1) are located in an electronics rack that is, typically, outside of the passenger section 220.

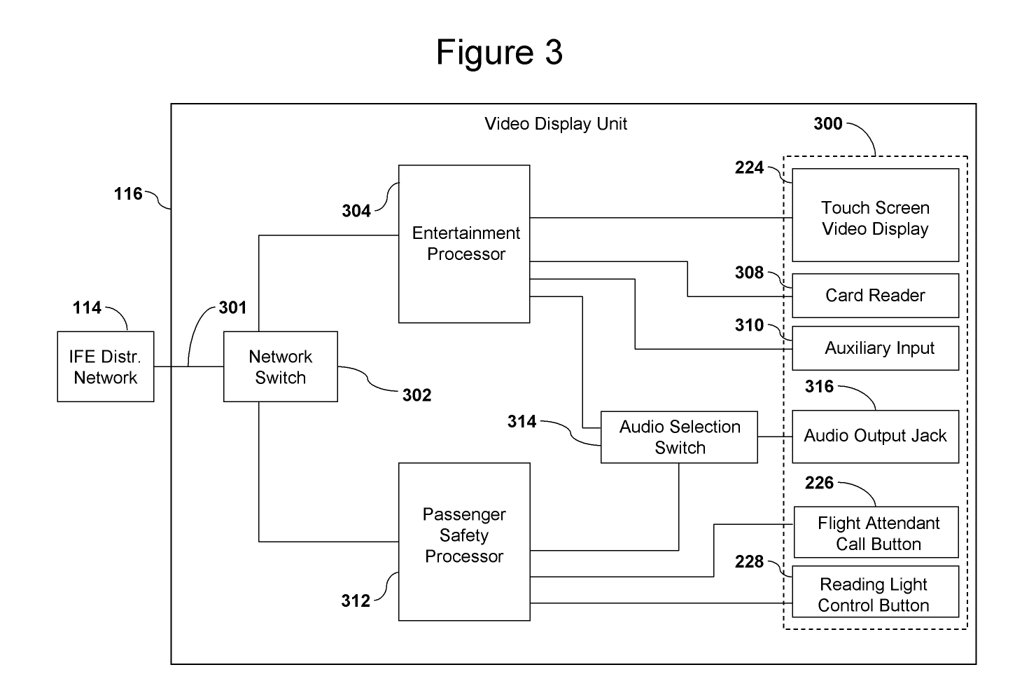

FIG. 3 shows an embodiment of VDU 116 in more detail. The illustrated VDU 116 has a user interface 300 that includes a touch screen display 224, a card reader 308, an auxiliary input 310, an audio output jack 316, a flight attendant call button 226 and a reading light control button 228. Other embodiments of the VDU 116 can include a user interface 300 with other user interface elements or other combinations of user interface elements. Typically, the touch screen display 224 is capable of displaying video.

In the illustrated embodiment, VDU 116 includes a network switch 302 having a network interface 301 for transmitting and receiving packets to and from IFE distribution network 114. Network switch 302 segregates signals inbound on network interface 301 between entertainment signals and passenger safety signals. Inbound entertainment signals include, for example, audio/video entertainment signals. Inbound passenger safety signals include, for example, PA audio packets and PA keyline status packets. Network switch 302 delivers entertainment signals to an entertainment processor 304 and delivers passenger safety signals to a passenger safety processor 312.

Generally, the passenger safety processor 312 regulates the audio signals outputted on audio output jack 316 based on PA keyline status and may regulate the video signals outputted on touch screen display 224. When PA system 140 is not in use, audio output jack 316 outputs entertainment audio signals received from entertainment processor 304 and touch screen video display 224 renders entertainment video signals received from entertainment processor 304. When PA system 140 is in use, audio output jack 316 outputs PA audio signals received from passenger safety processor 312 and touch screen video display 224 may render PA interrupt video signals received from entertainment processor 304.

In some arrangements, audio selection switch 314 selects PA audio signals as audio output signals based on an audio selection signal. For example, when passenger safety processor 312 receives from network switch 302 PA keyline status indicating that PA system 140 is in use, passenger safety processor 312 transmits an audio selection signal to audio selection switch 314 instructing audio selection switch 314 to select for transmission to audio output jack 316 PA audio signals made available by passenger safety processor 312 rather than selecting entertainment audio signals made available by entertainment processor 304. Moreover, passenger safety processor 312 can return a PA in progress signal to network switch 302, in response to which network switch 302 may transmit a PA in progress signal to entertainment processor 304, instructing entertainment processor 304 to select for transmission to touch screen video display 224 an interrupt video signal rather than entertainment video signals. In some embodiments, the entertainment processor 304 may select an interrupt video signal as a video output signal based on the PA in progress signal received from network switch 302. In some embodiments, passenger safety processor 312 may transmit a PA in progress signal on a direct communication line (not shown) to entertainment processor 304. In some embodiments, network switch 302 may transmit a PA in progress signal to entertainment processor 304 without prompting from passenger safety processor 312.

In some embodiments, the audio selection signal instructing audio selection switch 314 to select PA audio signals and the PA in progress signal are transmitted repeatedly for as long as PA keyline status indicates that PA system 140 is in use. In some embodiments, the audio selection signal instructing audio selection switch 314 to select PA audio signals and the PA in progress signal are transmitted only once. In some embodiments, the audio selection signal instructing audio selection switch 314 to select PA audio signals and the PA in progress signal are transmitted according to a time interval.

When passenger safety processor 312 does not receive PA keyline status indicating that PA system 140 is in use (for example, receives a PA keyline status signal indicating non-use of PA system 140) passenger safety processor 312 transmits an audio selection signal to audio selection switch 314 instructing audio selection switch 314 to select for transmission to audio output jack 316 entertainment audio signals made available by entertainment processor 304 rather than PA audio signals made available by passenger safety processor 312. Audio selection switch 314 selects entertainment audio signals as audio output signals based on the audio selection signal. In some embodiments, entertainment processor 304 selects entertainment video signals as video output signals based on the absence of a PA in progress signal indicating that PA system 140 is in use.

The video and audio signals outputted by touch screen video display 224 and audio output jack 316, respectively, are typically analog signals. The video signals may be extracted from packets and converted to analog form by network switch 302, entertainment processor 304, and/or touch screen video display 224, or by conversion and extraction logic not shown in FIG. 3. The audio signals may be extracted from packets and converted to analog form by network switch 302, passenger safety processor 312, audio selection switch 314 or audio output jack 316, and/or by conversion and extraction logic not shown in FIG. 3. The PA keyline status signals, audio selection signals and PA in progress signals described in relation to FIG. 3 may be transmitted in packets or analog form.

Card reader 308 receives card (e.g., credit card, debit card, gift card, frequent-flyer membership card, or the like) information when a card is read by the reader 308. The card reader 308 can transmit card input signals representing the card information to entertainment processor 304, which in turn can transmit the card input signals to network switch 302 for delivery to IFE distribution network 114 via network interface 301, and eventually to IFE servers 112 or other IFE component (not shown). In some embodiments, the card information is transmitted to an off-board receiver.

Auxiliary input 310 can receive auxiliary information from an attached device, such as a handset with passenger controls, and transmits auxiliary input signals carrying the auxiliary information to entertainment processor 304 for use by entertainment processor 304 applications. Entertainment processor 304 may in turn transmit the auxiliary input signals to network switch 302 for delivery to IFE distribution network 114 via network interface 301, and eventually to IFE servers 112 or other IFE component (not shown) depending on the specific application. Auxiliary input 310 may be, e.g., a universal serial bus (USB) port, Ethernet port, ⅛ inch port, ¼ inch port, IEEE 1394 port, or the like.

Flight attendant call button 226 is generally actuated when selected by a passenger. In some embodiments, the flight attendant call button 226 is a mechanically actuated button, though in other embodiments the flight attendant call button 226 is an electronic button, e.g., a selectable area rendered on the touch screen 224. When actuated, flight attendant call button 226 transmits a flight attendant call signal indicating flight attendant call button status to passenger safety processor 312, which in turn transmits the flight attendant call signal to network switch 302 for delivery to IFE distribution network 114 via network interface 301, and eventually to control system 139 (FIG. 1). When flight attendant call button 226 is actuated to the “on” position, the flight attendant call signal instructs the control system 139 to illuminate the passenger section attendant call light 132 and/or the galley section attendant call light 138. When flight attendant call button 226 is pressed into the “off” position, the flight attendant call signal instructs control system 139 to de-illuminate the passenger section attendant call light 132 and/or the galley section attendant call light 138 if there are no other pending calls. In some embodiments, flight attendant call signals prompt cabin management system 130 to provide other sensory output, such as audio output delivered via PA system 140. In some embodiments, rather than a button the flight attendant call button 226 is another type of input indicator, e.g., a switch, toggle, slider, or the like.

Reading light control button 228 can be actuated when selected by a passenger. In some embodiments, the reading light control button 226 is a mechanically actuated button, though in other embodiments the reading light control button 226 is an electronic button, e.g., a selectable area rendered on the touch screen 224. When actuated, reading light control button 228 transmits a reading light control signal indicating reading light control button status to passenger safety processor 312, which in turn transmits the reading light control signal to network switch 302 for delivery to IFE distribution network 114 via network interface 301, and eventually to control system 139 (FIG. 1). When reading light control button 228 is actuated to the “on” position, the reading light control signal instructs control system 139 to illuminate the passenger reading light 136. When reading light control button 228 is actuated into the “off” position, the reading light control signal instructs control system 139 to de-illuminate the passenger reading light 136. In some embodiments, rather than a button, the reading light control button 228 is another type of input indicator, e.g., a switch, toggle, slider, or the like.

Control system 139 can regulate the status, e.g., illuminated or de-illuminated, of attendant call lights 132, 138 based on flight attendant call signals received from VDU 116. The control system 139 can regulate the status, e.g., illuminated or de-illuminated, of passenger reading light 136 based on reading light control signals received from VDU 116.

In some embodiments, the reading light control button 228 operates as a dimmer (e.g., can increase and/or decrease the brightness, intensity, and/or amount of light from the passenger reading light 136). In these embodiments, reading light control signals instruct the cabin management control system 130 as to a desired brightness for the passenger reading light 136, wherein the reading light control signals are selected by the passenger safety processor 312 based on, e.g., how long the reading light control button was pressed.

In some embodiments, one or both of the flight attendant call button 226 or reading light control button 228 are integral to the touch screen display 224, e.g., as one or more buttons rendered on the touch screen display 224. In these embodiments, the passenger can control his or her corresponding attendant call light 138 and/or the passenger reading light 136 by selecting the button and/or buttons on the passenger's corresponding touch screen display 224. In some embodiments, the entertainment processor 304 instead of the passenger safety processor 312 interfaces between these buttons 226, 228 and network switch 302.

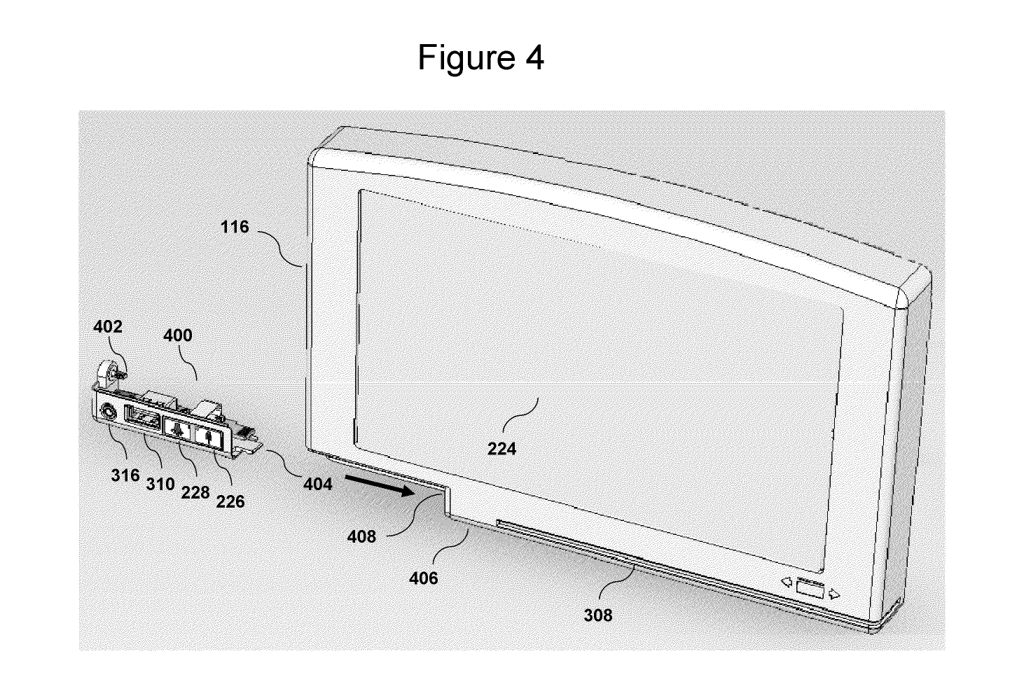

FIG. 4 illustrates an embodiment of VDU 116 in a state where a wide-body aircraft detachable user interface module 400 has been detached from a VDU base 406. Detachable module 400 has a plurality of user interface elements, including auxiliary input 310, audio output jack 316, flight attendant call button 226, and reading light control button 228. Detachable module 400 has electrical contacts 404 that interface with electrical contacts at a module receiving area 408 of VDU base 406 to operatively couple user interface elements 310, 316, 226, 228 to one or more of processors 304, 312 and render user interface elements 310, 316, 226, 228 operative. Detachable module 400 is engaged with VDU base 406 by moving detachable module 400 into abutment with receiving area 408 as indicated by the arrow. In the illustrated embodiment, detachable module 400 is held in engagement with VDU base 406 by a mounting screw 402 that threadably engages with a mounting screw hole (not shown) on VDU base 406 to mount detachable module 400 to VDU base 406. Also shown in the figure are touch screen video display 224 and card reader 308 that are integral with VDU base 406 and not detachable from VDU 116 in these embodiments.

In the event one or more of user the interface elements on the detachable user interface module 400 becomes inoperative or begins to perform sub-optimally, full functionality may be restored by disengaging detachable module 400 from VDU base 406 and attaching a spare detachable module to VDU base 406. Similarly, detachable module 400 may be readily replaced with a detachable module having a desired configuration of user interface elements, e.g., additional or different user interface elements. For example, in one arrangement the detachable module 400 for the first class portion of the passenger cabin includes auxiliary input 310, audio output jack 316, flight attendant call button 226 and reading light control button 228; and the detachable module 400 for the economy class portion of the passenger cabin includes only the flight attendant call button 226 and reading light control button 228.

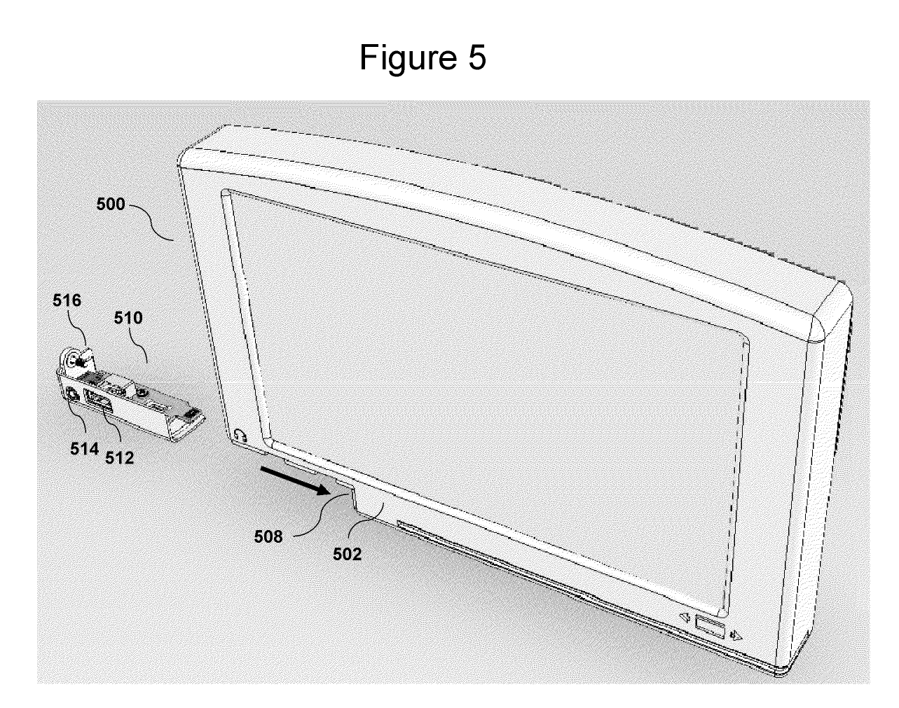

FIG. 5 illustrates an embodiment of a narrow-body VDU assembly 500. Detachable module 510 has a plurality of user interface elements, including an auxiliary input 512 and an audio output jack 514, but does not include a flight attendant call button 226 or a reading light control button 228. Detachable module 510 has electrical contacts that interface with electrical contacts on VDU base 502 to render user interface elements 512, 514 operative when detachable module 510 is engaged with VDU base 502 by moving detachable module 510 into abutment with a module receiving area 508 of VDU base 502 as indicated by the arrow. In the embodiment depicted, detachable module 510 is held in engagement with VDU base 502 by a mounting screw 516 that threadably engages with a mounting screw hole (not shown) on VDU base 502 to mount detachable module 510 to VDU base 502. In the event one or more of user interface elements 512, 514 becomes inoperative or begins to perform sub-optimally, full functionality may be restored by disengaging detachable module 510 from VDU base 502 and engaging a spare with VDU base 502. Likewise, detachable module 510 may be readily replaced with a detachable module having a desired configuration of user interface elements, e.g., additional or different user interface elements.

In some embodiments, the VDU base 402, 502 and or the detachable module 400, 510 includes indicia to indicate the function of the user interface elements or other features. For example, in FIG. 4, the card reader 308 includes indicia to indicate that a card may be slidably received the in reader 308. Likewise, FIG. 5 illustrates an instance of indicia (a symbolic representation of a pair of headphones) indicating the corresponding position of the audio output jack 514 when the detachable module 510 is mounted to the VDU base 502.

In some embodiments, a VDU base may interchangeably receive and render operative wide-body detachable modules (e.g., 400) and narrow-body detachable modules (e.g., 510). Among other advantages, deployment of a VDU base that can interchangeably support both wide-body and narrow-body detachable modules allows an airline to maintain and spare a single VDU base hardware design configuration across its entire fleet of wide-body and narrow-body aircraft.

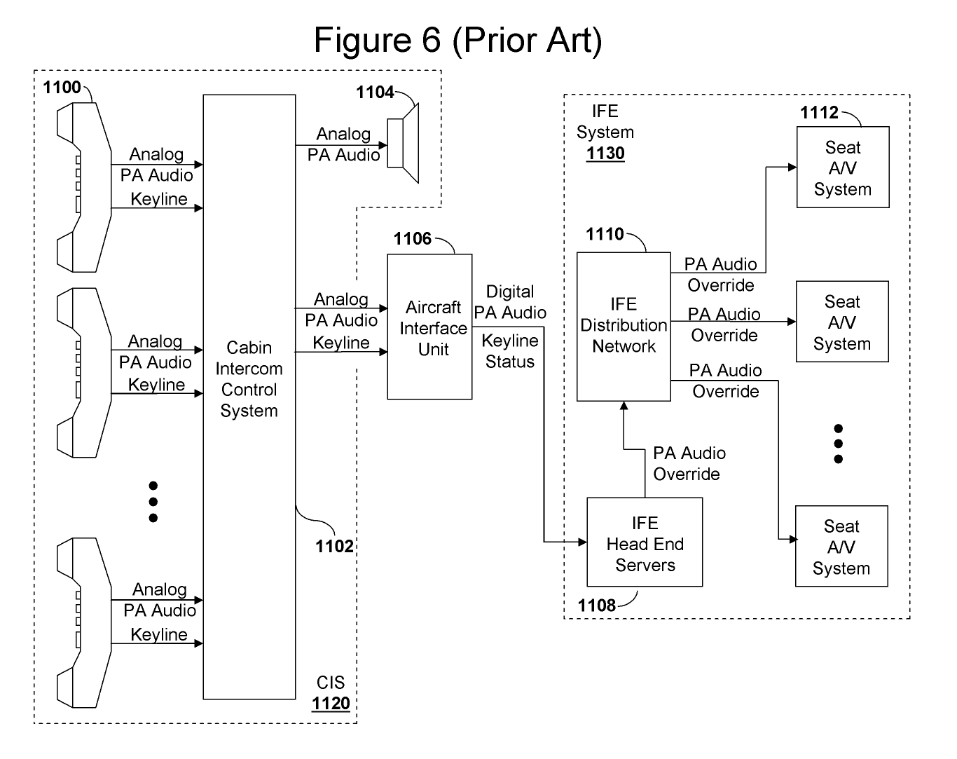

Turning to FIG. 6, a conventional inflight communication system that integrates an IFE system and a PA system is shown. This inflight communication system includes a cabin intercom system (CIS) 1120 and an IFE system 1130 communicatively coupled via an aircraft interface unit 1106. CIS 1120 has handsets 1100 that receive analog PA audio signals and a keyline signal from flight personnel. The keyline signal indicates whether the PA system is presently in use and may be activated by depressing a push-to-talk key on one or more of the handsets 1100. The analog PA audio signals and keyline signal are fed into a cabin intercom control system 1102 that delivers the analog PA audio signals to an overhead loudspeaker 1104 and delivers the analog PA audio signals and keyline signal to an aircraft interface unit 1106. Overhead loudspeaker 1104 outputs the analog PA audio signals. Aircraft interface unit 1106 digitizes the analog PA audio signals and delivers PA audio packets carrying the PA audio signals and keyline status packets indicating the keyline signal to IFE system 1130.

At IFE system 130, IFE head end servers 1108 receive the PA audio packets and keyline status packets, temporarily suspend transmission of entertainment packets, and deliver PA audio override packets and the PA audio packets to IFE distribution network 1110, which distributes the PA audio override and PA audio packets to seat audio/video systems 1112. Seat A/V systems 1112 convert digital PA audio signals carried in the PA audio packets to analog form and output analog PA audio signals to passengers sitting in the seats. However, PA audio in the conventional inflight communication system of FIG. 6 is routed through IFE head end servers 1108 en route to seat A/V systems 1112, which leaves PA audio output at seat A/V systems 1112 vulnerable to IFE head end server failure and risks unacceptably high latency between the PA audio output on the overhead loudspeaker 1104 and the PA audio output on the seat A/V systems 1112.

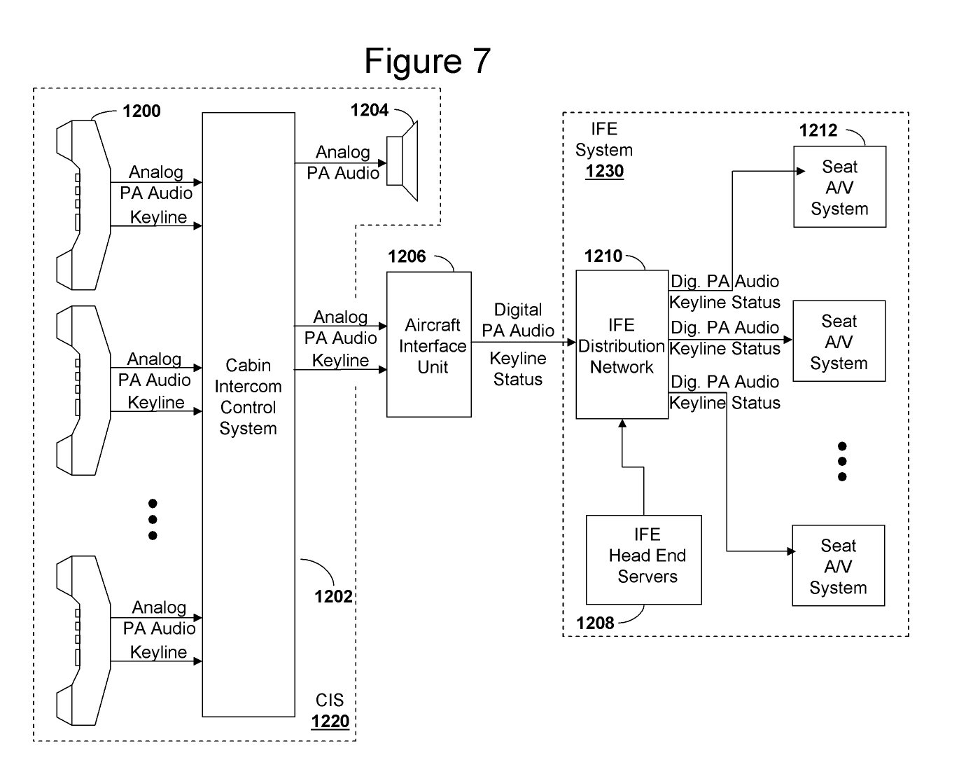

FIG. 7 shows an embodiment of an inflight communication system with high reliability PA audio output. The system includes a CIS 1220 and an IFE system 1230 communicatively coupled via an aircraft interface unit 1206.

As illustrated, the CIS 1220 has handsets (or other types of input devices) 1200 that receive analog PA audio signals and a keyline signal from flight personnel. The keyline signal indicates whether the PA system is presently in use and may be activated by, for example, depressing a push-to-talk key on one or more of the handsets 1200. The analog PA audio signals and keyline signal can be fed into a cabin intercom control system 1202 that delivers the analog PA audio signals to a public loudspeaker 1204 mounted to the cabin (e.g., in the ceiling) and/or to the analog PA audio signals and keyline signal to an aircraft interface unit 1206. The public loudspeaker 1204 outputs the analog PA audio signals to the passenger cabin, specific areas of the passenger cabin, other areas of the aircraft, or elsewhere. Generally, the aircraft interface unit 1206 typically digitizes the analog PA audio signals and delivers PA audio packets carrying the PA audio signals and keyline status packets reflecting the keyline signal to IFE system 1230.

At IFE system 1230, an IFE distribution network 1210 receives the PA audio packets and keyline status packets and distributes the packets to seat A/V systems 1212, which convert the digital PA audio signals carried in the PA audio packets to analog form and output analog PA audio signals to passengers at times indicated by the keyline status packets. As shown in FIG. 7, the communication flow bypasses IFE head end servers 1208, which can reduce or eliminate the risk of PA audio output failure on seat A/V systems 1212 due to server crashes and/or improves synchronization between PA audio output on public loudspeaker 1204 and the seat A/V systems 1212.

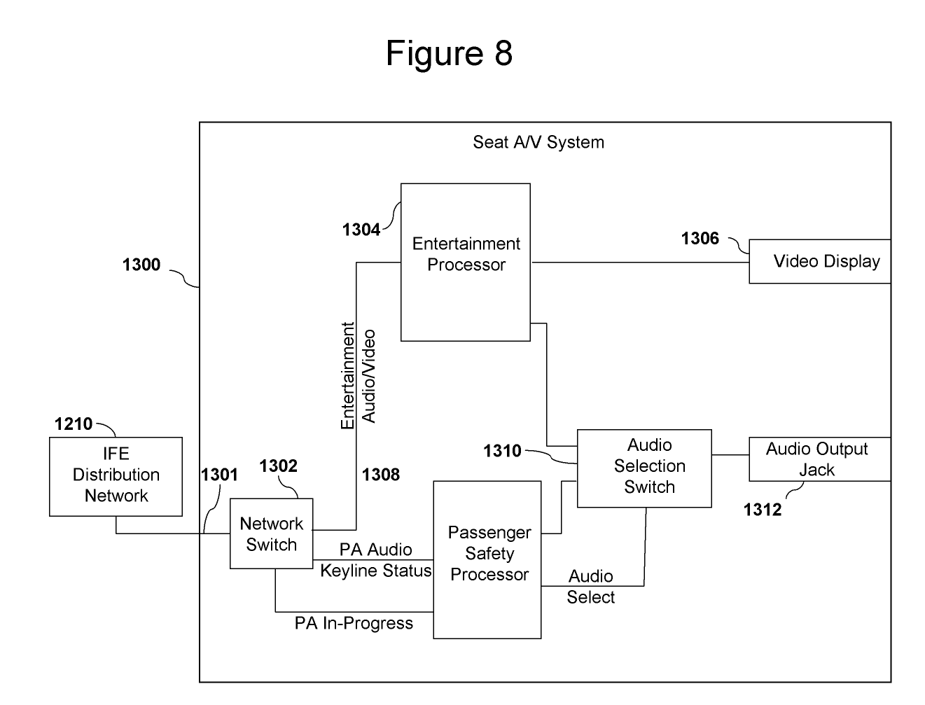

FIG. 8 shows an embodiment of a seat A/V system 1300, which is representative of one of the seat A/V systems 1212. Seat A/V system 1300 includes a network switch 1302 with a network interface 1301 for transmitting and receiving packets to and from IFE distribution network 1210. Network switch 1302 segregates packets inbound on network interface 1301 between entertainment packets and passenger safety packets. Inbound entertainment packets include, for example, A/V entertainment packets. Inbound passenger safety packets include, for example, PA audio packets and PA keyline status packets. Network switch 1302 delivers entertainment signals related to inbound entertainment packets to an entertainment processor 1304 and delivers passenger safety signals related to inbound passenger safety packets to a passenger safety processor 1308.

Passenger safety processor 1308 generally regulates the audio signals outputted on an audio output jack 1312 based on PA keyline status and may also regulate the video signals outputted on video display 1306. When none of handsets 1100 is in use, audio output jack 1312 outputs entertainment audio signals received (if any) from entertainment processor 1304 and video display 1306 renders entertainment video signals received (if any) from entertainment processor 1304. When one or more of handsets 1100 is in use, audio output jack 1312 outputs PA audio signals received from passenger safety processor 1308 and video display 1306 may render PA interrupt video signals received from entertainment processor 1304.

In some embodiments, audio selection switch 1310 selects PA audio signals as audio output signals based on the audio selection signal. For example, when passenger safety processor 1308 receives from network switch 1302 PA keyline status indicating that one or more of handsets 1100 is in use, passenger safety processor 1308 can transmit an audio selection signal to audio selection switch 1310 instructing audio selection switch 1310 to select for transmission to audio output jack 1312 the PA audio signals made available by passenger safety processor 1308 rather than selecting entertainment audio signals made available by entertainment processor 1304. In some arrangements, passenger safety processor 1308 returns a PA in-progress signal to network switch 1302, in response to which network switch 1302 may transmit a PA in-progress signal to entertainment processor 1304 instructing entertainment processor 1304 to select for transmission to video display 1306 an interrupt video signal rather than entertainment video signals, and entertainment processor 1304 may select an interrupt video signal as a video output signal based on the PA in-progress signal received from network switch 1302. The interrupt video signal may be, for example, a text message such as “Announcement in Progress” overlaid over a paused video frame. In some embodiments, passenger safety processor 1308 transmits a PA in-progress signal to entertainment processor 1304 on a direct communication line (not shown). In some embodiments, network switch 1302 may transmit a PA in-progress signal to entertainment processor 1304 without prompting from passenger safety processor 1308.

In some embodiments, the audio selection signal instructing audio selection switch 1310 to select PA audio signals and the PA in-progress signal are transmitted repeatedly for as long as PA keyline status indicates that one or more handsets 1100 is in use. In some embodiments, the audio selection signal instructing audio selection switch 1310 to select PA audio signals and the PA in progress signal are transmitted only once. In some embodiments, the audio selection signal instructing audio selection switch 1310 to select PA audio signals and the PA in progress signal are transmitted according to a time interval.

Generally, when passenger safety processor 1308 does not receive PA keyline status indicating that one or more handsets 1100 is in use, passenger safety processor 1308 transmits an audio selection signal to audio selection switch 1310 instructing audio selection switch 1310 to select for transmission to audio output jack 1316 the entertainment audio signals made available by entertainment processor 1304 rather than PA audio signals made available by passenger safety processor 1308. Audio selection switch 1310 typically selects entertainment audio signals as audio output signals based on the audio selection signal. In some embodiments, entertainment processor 1304 selects entertainment video signals as video output signals based on the absence of a PA in-progress signal indicating that one or more handsets 1100 is in use.

The video and audio signals outputted by video display 1306 and audio output jack 1312, respectively, are typically analog signals. The video signals may be extracted from packets and converted to analog form by network switch 1302, entertainment processor 1304, video display 1306, and/or conversion and extraction logic not shown in FIG. 8. The audio signals may be extracted from packets and converted to analog form by network switch 1302, passenger safety processor 1312, audio selection switch 1314, audio output jack 1312, and/or conversion and extraction logic not shown in FIG. 8. The PA keyline status signals, audio selection signals, and PA in progress signals described in relation to FIG. 8 may be transmitted in packets or analog form.

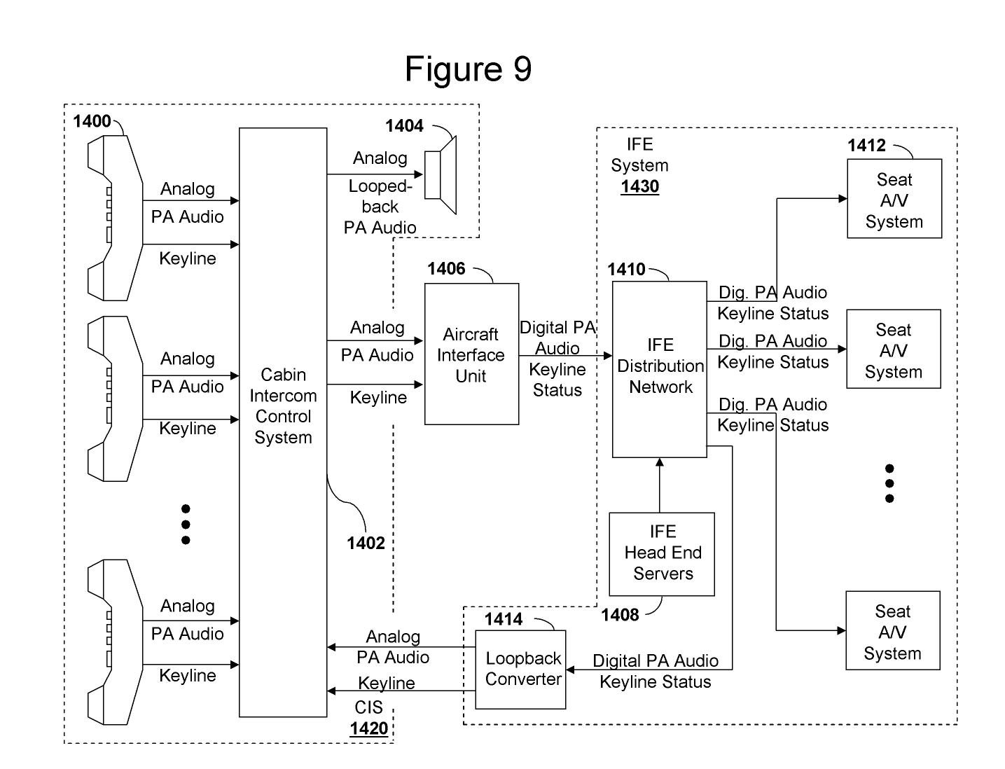

FIG. 9 shows an embodiment of an inflight communication system with high reliability and highly synchronized PA audio output. The illustrated system includes a CIS 1420 and an IFE system 1430 communicatively coupled via an aircraft interface unit 1406. CIS 1420 has handsets 1400 that receive analog PA audio signals and a keyline signal. The keyline signal generally indicates whether the PA system is presently in use and may be activated by, for example, depressing a push-to-talk key on one or more of the handsets 1400. The analog PA audio signals and keyline signal can be fed into a cabin intercom control system 1402 that delivers the analog PA audio signals and keyline signal to an aircraft interface unit 1406. As shown, the analog PA audio signals are not delivered directly to a public loudspeaker 1404, but instead are looped-back to the public loudspeaker after passing through IFE system 1430. Typically, aircraft interface unit 1406 digitizes the analog PA audio signals and delivers PA audio packets carrying the PA audio signals and keyline status packets reflecting the keyline signal to IFE system 1430.

At the IFE system 1430, an IFE distribution network 1410 receives the PA audio packets and keyline status packets and distributes the packets to seat A/V systems 1412, which convert the PA audio output signals to analog form and output analog PA audio signals to passengers at times indicated by the keyline status packets. In some embodiments, IFE distribution network 1410 distributes the packets to a loopback converter 1414 that converts the PA audio output signals and keyline status signals to analog form and returns analog PA audio signals and keyline signal to cabin intercom control system 1402 via a loopback interface. As shown, the cabin intercom control system 1402 can deliver the loopback PA audio signals to public loudspeaker 1404, which outputs the looped-back PA audio signals. As shown, the communication flow bypasses IFE head end servers 1408, which can reduce or eliminate the risk of PA audio output failure on seat A/V systems 1412 due to server crashes and/or improve synchronization between PA audio output on public loudspeaker 1404 and seat A/V systems 1412. In some embodiments, the inflight communication system routes PA audio through the IFE system 1430 before outputting the PA audio on public loudspeaker 1404, thereby further improving synchronization between PA audio output on public loudspeaker 1404 and seat A/V systems 1412.

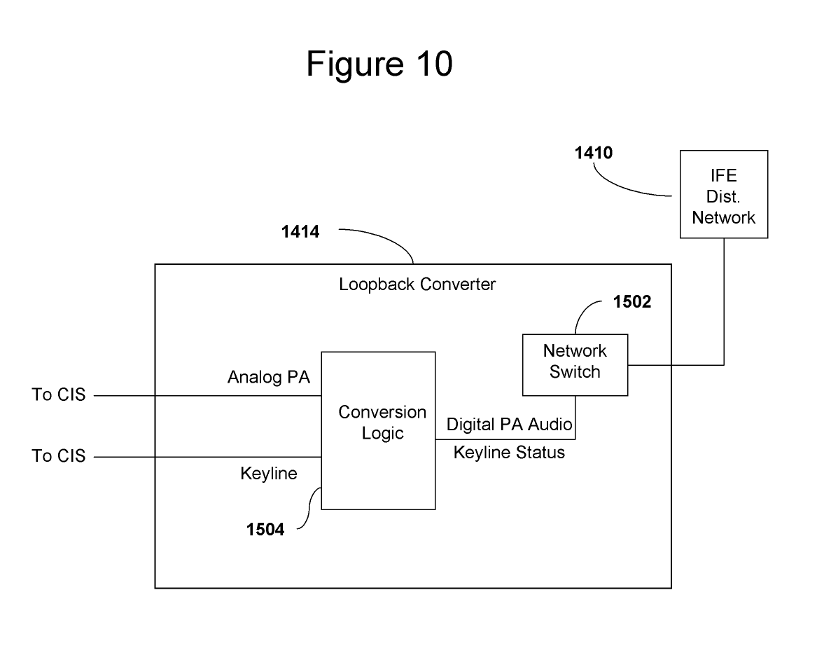

FIG. 10 shows an embodiment of a loopback converter 1414 in more detail. Loopback converter 1414 can include a network switch 1502 having an A/V input for receiving PA audio packets and keyline status packets from IFE distribution network 1410. Generally, the network switch 1502 delivers the PA audio and keyline status packets to conversion logic 1504, which can extract PA audio and keyline status signals from packets. The network switch 1502 can return to the CIS 1420 (FIG. 9) analog PA audio signals for outputting on public loudspeaker 1404 and/or keyline signal reflecting keyline status.

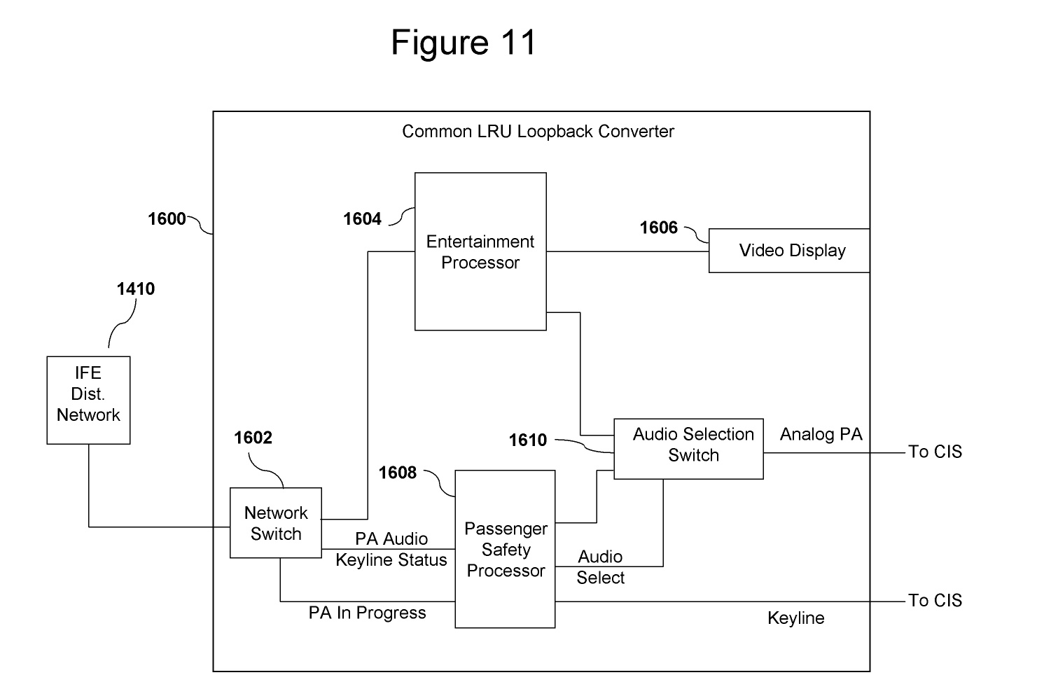

FIG. 11 shows an embodiment of a common LRU loopback converter 1600 for use in an inflight communication with high reliability and highly synchronized PA audio output. In some embodiments, a single LRU type (i.e., an LRU of a particular hardware design configuration) is used for both seat A/V systems and converter 1600 to obviate the need for a specially designed loopback LRU and achieve cost savings. In the illustrated embodiment, converter 1600 has elements 1602, 1604, 1606, 1608, 1610 that perform the functions described above in relation to their counterpart elements 1302, 1304, 1306, 1308, 1310, except that converter 1600 returns analog PA audio signals and keyline signal to the CIS 1420 instead of routing the PA audio signal to an audio output jack.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A video display unit for an inflight communication system, comprising:
a base having a video display, a network interface, and one or more processors operatively coupled with the network interface; and
a detachable module mounted to the base and having a plurality of user interface elements operatively coupled with at least one of the processors.

2. The video display unit of claim 1, wherein the user interface elements comprise an auxiliary input.

3. The video display unit of claim 1, wherein the user interface elements comprise an audio output jack.

4. The video display unit of claim 1, wherein the user interface elements comprise a flight attendant call button.

5. The video display unit of claim 1, wherein the user interface elements comprise a reading light control button.

6. The video display unit of claim 1, wherein the detachable module has electrical contacts that interface with electrical contacts on the base to render the user interface elements operative.

7. The video display unit of claim 1, wherein the detachable module is engaged with the base by moving the detachable module into abutment with the base.

8. The video display unit of claim 1, wherein the video display comprises a touch screen.

9. The video display unit of claim 1, wherein the base further comprises a credit card reader.

10. A video display unit base for an inflight communication system, comprising:
a video display;
a network interface;
one or more processors operatively coupled with the network interface; and
electrical contacts operatively coupled with at least one of the processors, wherein the base is adapted to interchangeably receive and render operative via the electrical contacts a first detachable module having a first set of user interface elements and a second detachable module having a second set of user interface elements, wherein the first and second sets include different user interface elements.

11. The base of claim 11, wherein the first detachable module is a wide-body aircraft detachable module and the second detachable module is a narrow-body aircraft detachable module.

12. The base of claim 11, wherein the first and second sets each include an auxiliary input and an audio output jack.

13. The base of claim 11, wherein the first set includes a flight attendant call button and a reading light control button and the second set does not include a flight attendant call button and does not include a reading light control button.

14. A video display unit assembly for an inflight communication system, comprising:
a base having a video display, a network interface, one or more processors operatively coupled with the network interface, and a module receiving area having electrical contacts; and
a detachable module integrally mountable to the base at the module receiving area and having a plurality of user interface elements, wherein when the detachable module is integrally mounted to the base at the module receiving area the user interface elements are operatively coupled via the electrical contacts with at least one of the processors.

15. The assembly of claim 16, wherein the user interface elements comprise an auxiliary input.

16. The assembly of claim 16, wherein the user interface elements comprise an audio output jack.

17. The assembly of claim 16, wherein the user interface elements comprise a flight attendant call button.

18. The assembly of claim 16, wherein the user interface elements comprise a reading light control button.

19. The assembly of claim 16, wherein the video display comprises a touch screen.

20. The assembly of claim 16, wherein the base further comprises a credit card reader.
